(19) United States
(12) Patent Application Publication
(10) Pub. No.: US 2018/0185703 A1
(43) Pub. Date: Jul. 5, 2018

(54) MOTION-GESTURE DETECTION EQUIPMENT, TREADMILL EQUIPMENT AND MOTION-GESTURE DETECTION METHOD

(71) Applicant: BOE TECHNOLOGY GROUP CO., LTD., Beijing (CN)

(72) Inventors: Enhui GUAN, Beijing (CN); Qi YANG, Beijing (CN); Weiqing GUO, Beijing (CN); Caikun YANG, Beijing (CN)

(73) Assignee: BOE TECHNOLOGY GROUP CO., LTD., Beijing (CN)

(21) Appl. No.: 15/705,940

(22) Filed: Sep. 15, 2017

(30) Foreign Application Priority Data
Jan. 3, 2017 (CN) 201710001380.4

(51) Int. Cl. A63B 24/00; G06F 3/01; A63B 22/02

(52) U.S. Cl. CPC A63B 24/0006; G06F 3/017; G06F 3/147; A63B 22/02; A63B 24/0062

(57) ABSTRACT

A motion-gesture detection equipment includes a display screen, an image-acquiring device and a processor. The image-acquiring device is to acquire in real time motion-gesture information of an exercising person. The processor is to compare in real time the motion-gesture information with standard motion-gesture information, and send a comparison result to the display screen for displaying in real time.

### CROSS-REFERENCE TO RELATED APPLICATION

This application claims priority to Chinese Patent Application No. 201710001380.4 filed on Jan. 3, 2017, which is incorporated herein by reference in its entirety.

### TECHNICAL FIELD

The present disclosure is related to the field of mechanical technology, and in particular to a motion-gesture detection equipment, a treadmill equipment and a motion-gesture detection method.

### BACKGROUND

Gym fitness has become an essential part of many young people's daily life, but only proper motion-gestures allow the body to exercise fully. Incorrect motion-gesture cannot achieve the purpose of exercising well, and may even cause damages to certain parts of the body during exercising. Displacement sensors may be used to detect motion-gestures of an exercising person, however, this manner only send data to the exercising person after the exercising person stops exercising and thus this manner is lack of timeliness.

### SUMMARY

In order to solve at least the above technical solution, embodiments of the present disclosure provide a motion-gesture detection equipment, a treadmill equipment, and a motion-gesture detection method.

Technical solutions of the present disclosure are as follow.

A motion-gesture detection equipment includes a display screen, an image-acquiring device and a processor. The image-acquiring device is configured to acquire in real time motion-gesture information of an exercising person. The processor is configured to compare in real time the motion-gesture information with standard motion-gesture information to obtain a comparison result, and send the comparison result to the display screen for displaying in real time.

Further, the motion-gesture detection equipment further includes a wireless transmission device. The wireless transmission device is configured to send the motion-gesture information acquired by the image-acquiring device to the processor.

Further, the display screen is further configured to display the motion-gesture information of the exercising person.

Further, the display screen is further configured to highlight first gesture information in the comparison result, and the first gesture information is information that is of the motion-gesture information and does not comply with the standard motion-gesture information.

Further, the image-acquiring device includes a camera.

One embodiment of the present disclosure further provides a treadmill equipment which includes the above motion-gesture detection equipment.

One embodiment of the present disclosure further provides a motion-gesture detection method, adopting the above motion-gesture detection equipment, the method includes: acquiring in real time motion-gesture information of an exercising person, and comparing in real time the motion-gesture information with standard motion-gesture information to obtain a comparison result and sending the comparison result to the display screen for displaying in real time.

Further, the motion-gesture detection method further includes highlighting first gesture information which is of the motion-gesture information and which does not comply with the standard motion-gesture information.

Further, the standard motion-gesture information includes gesture information of a head, a shoulder, an elbow, a hip, a leg of the exercising person.

### BRIEF DESCRIPTION OF THE DRAWINGS

FIG. 1 is a schematic view of a motion-gesture detection equipment according to an embodiment of the present disclosure;

FIG. 2 is a schematic view of two adjacent treadmill equipment according to an embodiment of the present disclosure; and

FIG. 3 is a schematic view of a treadmill equipment according to an embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise indicated. The implementations set forth in the following description of exemplary embodiments do not represent all implementations consistent with the disclosure. Instead, they are merely examples of devices and methods consistent with aspects related to the disclosure as recited in the appended claims.

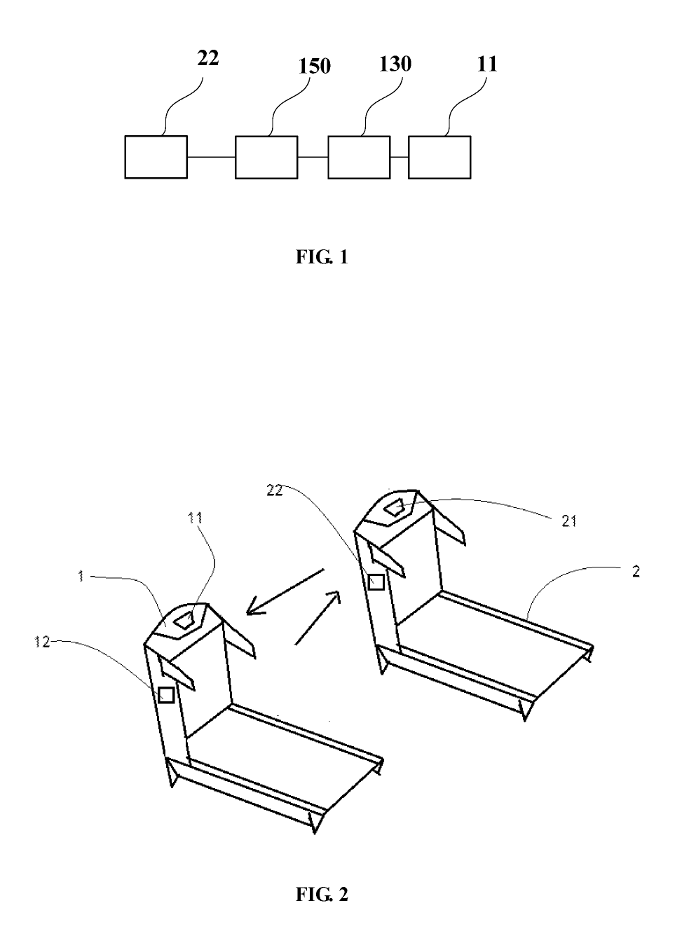

As shown in FIG. 1, a motion-gesture detection equipment is provided in an embodiment of the present disclosure, and includes an image-acquiring device 22 and a processor 130.

The image-acquiring device 22 is to acquire in real time motion-gesture information of an exercising person.

The processor 130 is to compare in real time the motion-gesture information with standard motion-gesture information to obtain a comparison result, and send the comparison result to a display screen 11 for displaying.

The image-acquiring device 22 can acquire in real time the motion-gesture information of the exercising person and the processor 130 can compare in real time the motion-gesture information with the standard motion-gesture information and send the comparison result to the display screen for displaying. Thus, the exercising person can adjust motion gestures in real time according to the comparison result, thereby achieving the purpose of exercising.

In one embodiment, in order to facilitate transmission of information, the motion-gesture detection equipment further includes a wireless transmission device 150.

The wireless transmission device 150 is to send the motion-gesture information acquired by the image-acquiring device 22 to the processor. In one embodiment, the wireless transmission device may be a wireless transmission device with the Bluetooth function or the Wi-Fi function.

Optionally, the display screen is further to display the motion-gesture information of the exercising person. The exercising person can visually adjust motion gestures according to the comparison result as well as the motion-gesture information of the exercising person displayed on the display screen.

In order to facilitating the exercising person to adjust the motion gestures in a faster and efficient way, the display screen is further to highlight first gesture information in the comparison result. The first gesture information is information that is in the motion-gesture information and does not comply with the standard motion-gesture information.

There is a variety of highlighting modes. For example, several body parts such as arms may be set as detection points in advance, and multiple corresponding standard gesture reference lines are displayed on the display screen. Then, when the first gesture information shows that a swing amplitude of the arm of the exercising person is too large and exceeds a swing amplitude of the standard motion gesture, one standard gesture reference line which represents arm detection points is red, thereby prompting the exercising person to reduce in real time the swing amplitude of the arms.

In one embodiment, the motion-gesture detection equipment can be applied to a treadmill equipment, the image-acquiring device may be a camera disposed at a treadmill equipment adjacent to one treadmill equipment which is used by the exercising person. The display screen may be a display screen of the treadmill equipment which is used by the exercising person. In other embodiment, the image-acquiring device may be a camera disposed at other position, as long as the image-acquiring device can acquire in real time the motion-gesture information of the exercising person.

When the image-acquiring device is disposed at the treadmill equipment adjacent to the one treadmill equipment, which is used by the exercising person, it helps to acquire the motion-gesture information of the exercising person. When the display screen of the treadmill equipment, which is used by the exercising person, is used to display the comparison result and/or the motion-gesture information of the exercising person, it facilitates the exercising person to view that information.

It should be noted, the motion-gesture detection equipment can also be applied to other fitness machinery, and is not limited to be applied to the treadmill equipment.

Further, when the motion-gesture detection equipment is applied to the treadmill equipment, the processor may be integrated into the treadmill equipment which is used by the exercising person, thereby saving space and being user-friendly.

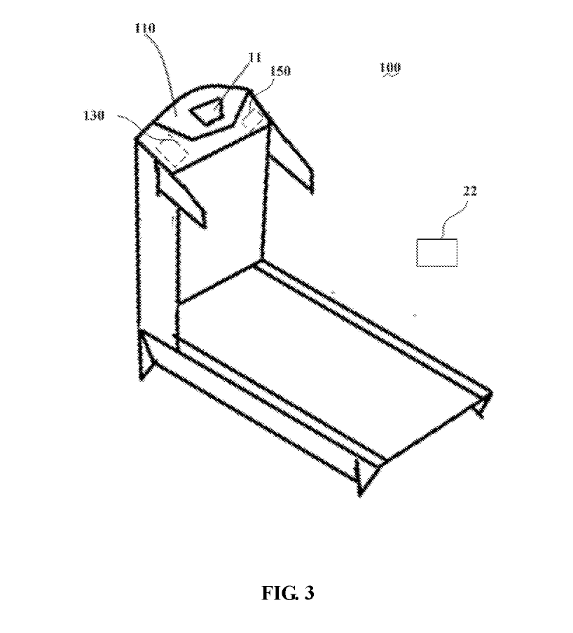

FIG. 2 shows two adjacent treadmill equipment including a first treadmill equipment 1 and a second treadmill equipment 2. The second treadmill equipment 2 is provided with a second display screen 21. A second camera 22 is provided at one side of the second treadmill equipment 2 adjacent the first treadmill equipment 1. A first camera 12 is provided at one side of the first treadmill equipment 1 away from the second treadmill equipment 2. The first camera 12 is to acquire motion-gesture information of an exercising person who is on one treadmill equipment which is located at the one side of the first treadmill equipment 1 away from the second treadmill equipment 2. The first treadmill equipment 1 is provided with a first display screen 11.

Be taking a person running on the first treadmill equipment 1 as an example, the standard motion-gesture information may be set in advance as follows:

head and shoulder: head right ahead, stretching the shoulder;

arm and hand: a swing amplitude of the arm not exceeding a midline of the body, an angle of the elbow is about 90 degrees;

trunk and tip: the trunk keeping upright, not swing left and right;

setting the head, the shoulder, the elbow, the hip and the leg as basic data detection points (the amount and positions of the detection points may be set according to actual need).

Motion-gesture information of the exercising person on the first treadmill equipment 1, which is acquired by the second camera 22 in real time, is transmitted in real time to the first treadmill equipment 1 through wireless communication. The processor compares in real time the motion-gesture information with standard motion-gesture information, and then the comparison result as well as the motion-gesture information of the exercising person are displayed on the first display screen 11.

For the convenience of the exercising person to understand the comparison result, the comparison result may be shown in such a manner that one corresponding standard gesture reference line is shown in different color. For example, if motion-gesture information at one detection point exceeds the standard gesture reference line, then the standard gesture reference line is shown in red color. For example, when a swing amplitude of the arm of the exercising person is too large and exceeds a swing amplitude of the standard motion gesture, one standard gesture reference line which represents an arm detection point is shown in red, otherwise, the standard gesture reference line which represents the arm detection point is shown in green. The exercising person can adjust his running posture and amplitude of motion.

The motion gesture of the exercising person may also be displayed on the first display screen 11 in form of images. When the motion-gesture information at one detection point does not comply with the standard gesture reference line, one corresponding body part is highlighted with red circle or the like in the image, so that the exercising person can acquire the information intuitively and then he can adjust his motion gesture accordingly.

As shown in FIG. 3, a treadmill equipment 100 is provided according to an embodiment of the present disclosure, and includes a treadmill 110 and a motion-gesture detection equipment. The motion-gesture detection equipment includes a processor 130, a wireless transmission device 150 and an image-acquiring device 22.

The image-acquiring device 22 is to acquire in real time motion-gesture information of an exercising person. The wireless transmission device 150 is to send the motion-gesture information acquired by the image-acquiring device 22 to the processor 130. The processor 130 is to compare in real time the motion-gesture information with standard motion-gesture information, and send a comparison result to a display screen 11 of the treadmill 110 for displaying in real time.

In one embodiment shown in FIG. 3, the processor 130 and the wireless transmission device 150 are disposed within the treadmill 110. The image-acquiring device 22 may be disposed at the treadmill 110 or at an outside of the treadmill 110. For example, as shown in FIG. 3, the acquiring device 22 may be a camera disposed at an outside of the treadmill 110 and is separated from the treadmill 110 by a certain distance, so as to acquire the gesture information of the exercising person in real time in a better manner.

A motion-gesture detection method is provided according to an embodiment of the present disclosure. The motion-gesture detection method may use the above motion-gesture detection device, and includes:

acquiring in real time motion-gesture information of an exercising person;

comparing in real time the motion-gesture information with standard motion-gesture information to obtain a comparison result, and sending the comparison result to a display screen for displaying.

Further, the motion-gesture detection method further includes highlighting first gesture information which is of the motion-gesture information and which does not comply with the standard motion-gesture information.

Further, the motion-gesture information includes gesture information of the head, the shoulder, the elbow, the hip, the leg of the exercising person.

Further, when the motion-gesture detection equipment is applied to one treadmill equipment, the motion-gesture detection method includes:

acquire in real time motion-gesture information of a running person;

transmitting in real time the motion-gesture information to a display screen of the treadmill equipment which is used by the running person, and displaying the motion-gesture information; and

comparing in real time the motion-gesture information with standard motion-gesture information, and transmitting a comparison result to display screen of the treadmill equipment which is used by the running person, and displaying the comparison result.

The forgoing descriptions are only optional embodiments of the present disclosure, and it should be noted that numerous improvements and substitutions may further be made by those skilled in the art without being departing from the principle of the present disclosure, and those improvements and substitutions shall fall into the scope of protection of the present disclosure.

What is claimed is:

1. A motion-gesture detection equipment comprising:
a display screen,
an image-acquiring device configured to acquire in real time motion-gesture information of an exercising person, and
a processor configured to compare in real time the motion-gesture information with standard motion-gesture information to obtain a comparison result, and send the comparison result to the display screen for displaying in real time.

2. The motion-gesture detection equipment of claim 1, further comprising a wireless transmission device,
wherein the wireless transmission device is configured to send the motion-gesture information acquired by the image-acquiring device to the processor.

3. The motion-gesture detection equipment of claim 1, wherein the display screen is further configured to display the motion-gesture information of the exercising person.

4. The motion-gesture detection equipment of claim 1, wherein the display screen is further configured to highlight first gesture information in the comparison result, and the first gesture information is information that is of the motion-gesture information and does not comply with the standard motion-gesture information.

5. The motion-gesture detection equipment of claim 1, wherein the image-acquiring device includes a camera.

6. A treadmill equipment comprising:
a treadmill with a display screen, and
a motion-gesture detection equipment,
wherein the motion-gesture detection equipment comprises:
an image-acquiring device configured to acquire in real time motion-gesture information of an exercising person, and
a processor configured to compare in real time the motion-gesture information with standard motion-gesture information to obtain a comparison result, and send the comparison result to the display screen for displaying in real time.

7. The treadmill equipment of claim 6, further comprising a wireless transmission device,
wherein the wireless transmission device is configured to send the motion-gesture information acquired by the image-acquiring device to the processor.

8. The treadmill equipment of claim 7, wherein the wireless transmission device is integrated in the treadmill.

9. The treadmill equipment of claim 6, wherein the image-acquiring device includes a camera.

10. The treadmill equipment of claim 6, wherein the image-acquiring device includes a camera which is provided outside of the treadmill and is spaced from the treadmill.

11. The treadmill equipment of claim 6, wherein the processor is integrated in the treadmill.

12. A motion-gesture detection method, adopting the motion-gesture detection equipment of claim 1, the method comprising:
acquiring in real time motion-gesture information of an exercising person, and
comparing in real time the motion-gesture information with standard motion-gesture information to obtain a comparison result, and sending the comparison result to the display screen for displaying in real time.

13. The motion-gesture detection method of claim 12, further comprising:
highlighting first gesture information which is of the motion-gesture information and which does not comply with the standard motion-gesture information.

14. The motion-gesture detection method of claim 12, wherein the standard motion-gesture information comprises gesture information of a head, a shoulder, an elbow, a hip, a leg of the exercising person.
